(19) United States
(12) Patent Application Publication
(10) Pub. No.: US 2004/0079032 A1
(43) Pub. Date: Apr. 29, 2004

(54) Seal and method

(75) Inventors: Stephen Russell, Raymond, OH (US); John Collins, Raymond, OH (US); Kazuo Onodera, Raymond, OH (US)

Correspondence Address: RANKIN, HILL, PORTER & CLARK LLP, 700 HUNTINGTON BUILDING, 925 EUCLID AVENUE, CLEVELAND, OH, 44115-1405, US

(73) Assignee: Honda Giken Kogyo Kabushiki Kaisha, Minato-ku (JP)

(21) Appl. No.: 10/278,337

(22) Filed: Oct. 23, 2002

(51) Int. Cl. E06B 7/16

(52) U.S. Cl. 49/498.1

(57) ABSTRACT

A seal includes a deformable body portion and a base portion. The base portion defines a base cavity and an aperture extending from the base cavity to a groove extending along the outer surface of the base portion. The aperture is adapted to receive a post fastener, while the groove is adapted to receive a radial stop of the post fastener in a recessed position. The base portion includes first and second lips that are received within clip portions provided by a clip. The seal is secured to the peripheral surface of the door such that a first portion of the seal is attached to the door with the clips while a second portion of the seal is attached to the door with the post fasteners.

### BACKGROUND OF THE INVENTION

1. Field of the Invention

The present invention generally relates to a seal, and particularly to a seal for a vehicle closure and a method for attaching the seal to a vehicle.

2. Discussion of Related Art

A vehicle closure, such as a door, is subject to differing seal requirements around its periphery. This is because sections of the door periphery are subjected to differing elements and forces compared to other sections. For example, a leading edge of a door on a moving vehicle is subject to infiltration by rainwater driven at it by at least the speed of the moving vehicle, whereas a trailing edge of the door may be subject to little or no rainwater infiltration. Consequently, it is sometimes desirable that a seal at the leading edge has a sealing function that is more robust than at the trailing edge. Likewise, due to the force of gravity sometimes it may be desirable to have the sealing function for an upper portion of the door to be more robust than a lower portion of the door. A robust sealing function sometimes must be balanced with such factors as manufacturing time, material and expense necessary to affect the proper amount of sealing function.

Traditionally, a seal can be structurally configured to attach to a vehicle either by a clip or by a seal holder. Typical clips, which may be thought of as post fasteners, include screws, rivets, pop rivets, and the like. The clips provide a relatively quick and easy attachment of the seal to the vehicle door, but provide a sealing function (i.e., a “good seal”) that is unfavorable when compared to a sealing function provided by the holder. In contrast, the holder provides a relatively favorable sealing function, but is comparatively more difficult and time-consuming to attach to the vehicle door.

Accordingly, in the past two differing types of seals were used. The first type secures to the vehicle door using clips or post fasteners, and the second type secures using seal holders. Where a changeover in seal type occurs along a length of the seal, the two types of seal are joined together at a joint.

Forming the first type of seal requires a first mold and associated tooling, while forming the second type of seal requires a second mold and associated tooling. Additional molds and/or tooling are required to join the two types of seals. It is desirable to reduce, consolidate or eliminate the number or types of seals and thereby reduces the capitol equipment expense associated with additional molds and/or tooling.

### SUMMARY OF THE INVENTION

The present invention provides a seal and a method of attaching the seal. The seal includes a deformable body portion and a base portion. The base portion has an inner surface and an outer surface. The base inner surface defines a cavity. The base outer surface defines a longitudinal groove. An aperture extends through the base portion from the base cavity to the groove and can receive a post fastener.

In further accordance with the present invention, the base portion includes first and second lips. Each of the lips has a lip surface. Each lip surface is adapted to be received within a corresponding portion of a seal holder to secure the base portion to the seal holder.

In further accordance with the invention, the vehicle seal can secure along the entire length of the seal using both a seal holder and a clip. A first portion of the seal is secured to the door at a peripheral edge of the door with clips. A second portion of the seal is secured to the door at the peripheral edge of the door with a seal holder.

### BRIEF DESCRIPTION OF THE DRAWINGS

These and further features of the invention will be apparent with reference to the following description and drawings, wherein:

FIG. 1 is a schematic side view of a vehicle comprising a preferred embodiment of the seal according to the present invention;

FIG. 2 is schematic side view of a seal according to the invention;

FIG. 3 is a cross-sectional view of the seal of FIG. 2 along the line 3-3;

FIG. 4 is a cross-sectional view of the seal of FIG. 2 along the line 4-4 attached to a seal holder; and

FIG. 5 is a cross-sectional view of the seal of FIG. 2 along the line 5-5 attached to a clip or post fastener.

### DETAILED DESCRIPTION OF PREFERRED EMBODIMENTS

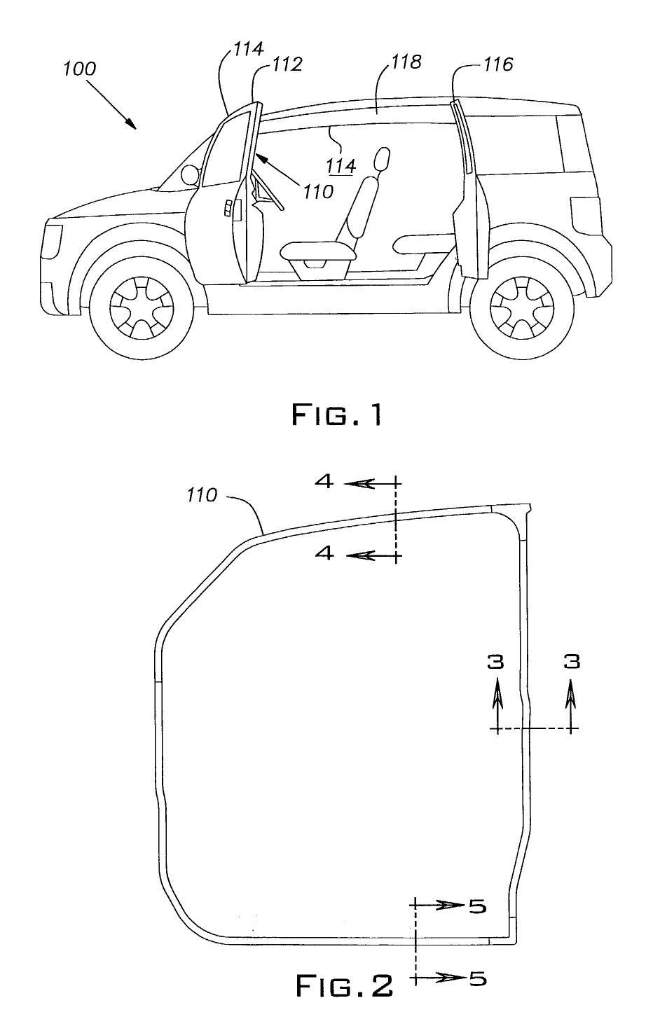

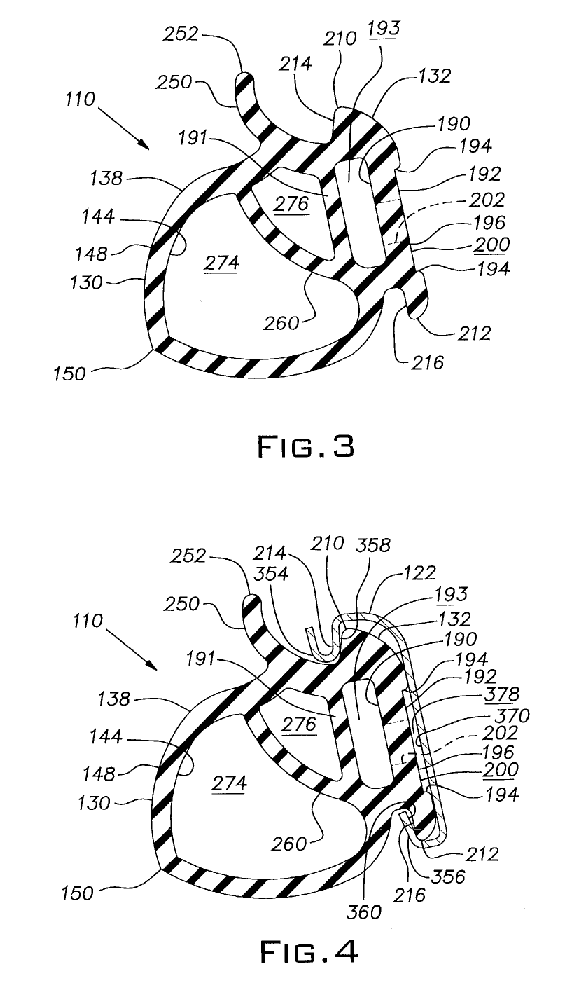

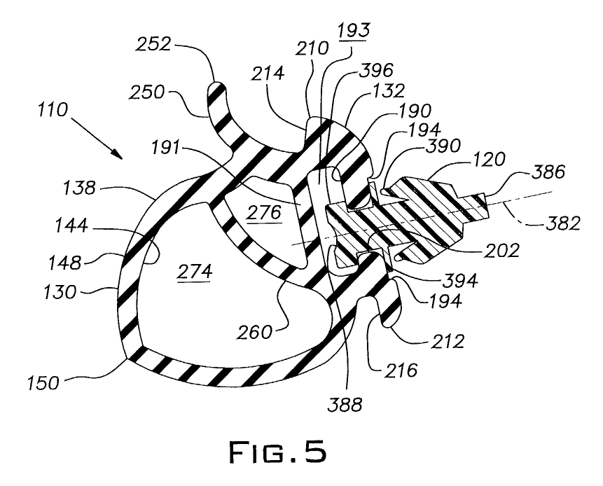

A vehicle 100 comprising a vehicle door seal 110 according to a preferred embodiment of the invention is shown in FIG. 1. With reference to FIG. 2, the seal 110 attaches to a peripheral edge 112 of a vehicle door 114 to seal the door 114 to the vehicle 100. In the illustrated vehicle, when the door 114 is closed, the seal 110 contacts against both the door 114 and either another door 116, or a surrounding body panel or surface 118 of the vehicle 100. The seal 110 attaches to the door 114 both by using a clip or post fastener 120 and by using a seal holder 122 (FIGS. 4-5).

With reference to FIGS. 3-5, the seal 110 includes a deformable body portion 130 and a base portion 132. The seal 110 is elastomeric and flexible and is preferably formed of synthetic foamed rubber. The body portion 130 includes a body wall 138 having an inner surface 144 and a sealing outer surface 148. A crest 150 runs longitudinally along the body portion 130 to divide the sealing outer surface 148 into two generally equal halves.

The base portion 132 is integrally formed with the body portion 130. The base portion 132 has a base inner surface 190 and a base outer surface 192. An inner or secondary wall 191 cooperates with the base portion 132 to define a base cavity 193, as illustrated. The base outer surface 192 has side surfaces 194 and a bottom surface 196 that together define a longitudinal groove 200.

The base portion 132 further defines an aperture 202 extending between the base cavity 193 and the groove 200. The illustrated aperture 202 is one of a plurality of identical apertures that are preferably evenly spaced along the length of the seal 110.

The base portion 132 also includes a first lip 210, a second lip 212, and a sealing lip 250. The first lip 210 has a first lip surface 214, and the second lip 212 has a second lip surface 216. The sealing lip 250 extends from the body portion 130 to a free end 252.

A bridge support 260 extends from one side of the body wall 138 to the other side of the body wall 138. The bridge support separates or divides the seal interior into first and second cavities 274, 276. The first cavity 274 is surrounded by the inner surface 144 of the body wall 138 and the bridge support 260. The second cavity 276 is bounded by the bridge support 260, the secondary wall 191, and a portion of the body wall 138, as illustrated.

With reference to FIG. 4, the seal 110 is shown in combination with a metal seal holder 122. The seal holder 122 may be one of a plurality of holders that are used to secure the seal to the door 114, preferably at upper portions of the door where secure attachment and enhanced sealing is required. Alternatively, the seal holder 122 may be integrally formed with the door 114 and extend along at least a portion of the door periphery. Alternatively, the holder 122 may be affixed to the door by mechanical fasteners.

Specifically, the holder 122 has a first portion 354 and an opposing second portion 356. The first portion 354 has a first inner surface 358, and the second portion 356 has a second inner surface 360. The holder portions 354, 356 cooperate with each other and a base surface 370 to define a retaining space 378 into which the seal 110 is inserted.

The seal first lip 210 is received within the first portion 354 and against the first inner surface 358 while the seal second lip 212 is received within the second portion 356 and against the second inner surface 360. Thus, the base portion 132 of the seal 110 is secured in the retaining space 378, as illustrated.

With reference to FIG. 5, the seal 110 is shown in combination with a clip or post fastener 120, which is preferably formed from a plastic material such as nylon. The illustrated clip 120 is one of a plurality of identical fasteners that are used to secure the seal to the door 114, preferably at lower portions of the door where enhanced sealing is not required. The clip 120 defines an axis 382 and has a first end 386 and a second end 388 axially spaced from the first end 386. The first end 386 extends an aperture (not shown) in the door 114. A radial stop 394 and a resilient arm 390 extend outward from the clip 120 at a location between the first and second ends 368, 388.

As will be appreciated by those skilled in the art, the stop 394 and arms 390 are spaced apart a distance such that, when the clip 120 is secured to the door 114, the door is received or trapped between the stop 394 and the arms 390. The thickness of the stop 394 (i.e., in the axial direction) is equal to, or slightly less than, the height of the side surfaces 194 and thereby permits the stop 394 to be completely received within the groove 200. Accordingly, the stop 394 does not interfere with snug engagement of the seal 110 to the door 114, and permits the base outer surface 192 surrounding the groove 200 to directly contact the door 114.

The clip or post fastener 120 also includes a flared button 396 at the second end 388 thereof. The button 396, which extends outwardly from the clip 120, is larger than the diameter of the aperture 202 so that the aperture is elastically enlarged as the base portion button 396 is pushed therethrough, and then snaps back to its original position to retain the button 396, and hence the clip 120, within the seal base portion 132.

Preferably, a plurality of clips 120 are preliminarily secured to the seal 110 to define a subassembly that is subsequently secured to the door 114 by simply pushing the clips/seal and thereby snapping the door surface between the stop 394 and the arms 390.

During assembly of the seal 110 to the door 114, holder(s) 122 and clips 120 cooperate with each other to form a continuous array of securing means at the peripheral edge 112 of the door 114. The holder(s) 122 secure the seal 110 along the upper half of the peripheral edge 112 of the door 114 while the clips 120 secure the seal 110 along the lower half of the peripheral edge 112 of the door 114.

When compressed between the door 114 and the body panel 118, the body portion 130 of the seal 110 deforms to seal against the body panel 118. Specifically, the sealing outer surface 148 contacts against the body panel 118 and seals thereto. The crest 150 directs the body portion 130 to deform in a predetermined direction and manner. The body wall 138 resiliently bends in response to pressure applied by the closing vehicle door 114, and the cavity 146 changes configuration or shape.

When the vehicle 100 is driven in inclement weather, water impacts against the vehicle 100 and the seal 110 due to operation of the vehicle 100 and due to gravity. The seal holder(s) 122 provide a strong sealing attachment at the more demanding locations, e.g., the top and front of the door 114. Therefore, the holder(s) 122 serve to secure the seal to the door at locations wherein improved sealing and attachment are required, it being noted that this improved sealing and attachment comes at the expense of more difficult and, hence more expensive in terms of labor, attachment. The clips or post fasteners 120 are relatively easy to assemble with the seal 110, but do not provide as strong a sealing attachment as the holder 122. Therefore, the clips 120 serve to secure the seal to the door at locations where less sealing/attachment is required and, thus, where a less labor intensive and, thus more economical, attachment device may be used. Therefore, the present invention realizes a sealing assembly that provides improved sealing at locations that require it, while providing a lower cost alternative attachment device where appropriate.

In alternative embodiments of the present invention, the seal 110 is used in combination with a hood or a trunk, rather than a door. In other alternative embodiments, a single clip continuously extends along the entire upper peripheral edge of a door. Optionally, a bead of adhesive can be placed in the holder 122 on the base surface 370 to provide an additional means of securing the seal 110 in the clip 122.

The embodiments described herein are examples of structures, systems and methods having elements corresponding to the elements of the invention recited in the claims. This written description may enable those skilled in the art to make and use embodiments having alternative elements that likewise correspond to the elements of the invention recited in the claims. The intended scope of the invention thus includes other structures, systems and methods that do not differ from the literal language of the claims, and further includes other structures, systems and methods with insubstantial differences from the literal language of the claims.

What is claimed is:

1. A seal for sealing a peripheral edge of a vehicle closure, comprising:
a deformable body portion comprising a body wall having an inner surface defining a body cavity, and a sealing outer surface; and
a base portion connected to the body portion, and having an inner surface and an outer surface, the base inner surface defining a base cavity, and the base outer surface defining a longitudinal groove and an aperture extending through the base portion from the base cavity to the groove, the aperture being adapted to receive a post fastener, the base portion comprising a first lip, and a second lip spaced from the first lip, the first and second lips each having a lip surface, each lip surface being configured to contact against a corresponding surface of a seal holder;
whereby the vehicle seal can be secured to the peripheral edge of the vehicle closure by the holder and the post fastener.

2. The seal as defined in claim 1, wherein the post fastener comprises a stop having a thickness dimension and the groove has a depth sufficient to accommodate the stop thickness.

3. The seal as defined in claim 1, wherein the closure is a door.

4. A vehicle seal assembly, comprising:
a seal holder having a first portion and a second portion;
a post fastener; and
a seal including a deformable body portion and a base portion connected to the body portion, the base portion having an inner surface and an outer surface, the base inner surface defining a base cavity, and the base portion defining an aperture extending from the base cavity to the base outer surface, the aperture being adapted to receive the post fastener,
the base portion further comprising first and second lips, each of the lips having a lip surface, the first lip being received within the first portion of the seal holder and the second lip being received within the second portion of the seal holder;
whereby the vehicle seal may be attached to a peripheral edge of a vehicle closure by the holder and the post fastener.

5. The assembly as defined in claim 4, wherein the base outer surface further defines a longitudinal groove having a depth, and the post fastener further comprises a stop configured to abut a vehicle surface, and the stop has a thickness sized to be received within the groove so that the stop nests within the groove.

6. The assembly as defined in claim 4, wherein the seal is disposed around a peripheral edge of a vehicle closure.

7. The assembly as defined in claim 6, wherein the closure is a door.

8. A method of releasably sealing a vehicle door to a vehicle, comprising the steps of:
providing a vehicle seal, the vehicle seal cooperating with the door to secure said seal to said door with at least one seal holder and at least one post fastener;
securing a first portion of the seal to the door peripheral edge with a post fastener;
securing a second portion of the seal to the door peripheral edge with the seal holder.

9. A seal for sealing a peripheral edge of a vehicle closure, comprising:
a deformable body portion comprising a body wall having an inner surface defining a body cavity, and a sealing outer surface; and
a base portion connected to the body portion, and having an inner surface and an outer surface, the base inner surface defining a base cavity, and the base outer surface defining a longitudinal groove and an aperture extending through the base portion from the base cavity to the groove, the aperture being adapted to receive a post fastener, the base portion comprising a first lip, and a second lip spaced from the first lip, the first and second lips each having a lip surface, each lip surface being configured to contact against a corresponding surface of a seal holder on the peripheral edge of the vehicle closure;
whereby the vehicle seal can be secured to the peripheral edge of the vehicle closure by at least one of the holder and the post fastener.

10. The seal as defined in claim 9, wherein the post fastener comprises a stop having a thickness dimension and the groove has a depth sufficient to accommodate the stop thickness.

11. The seal as defined in claim 9, wherein the closure is a door.
